(19) United States
(12) Patent Application Publication
(10) Pub. No.: US 2012/0281954 A1
(43) Pub. Date: Nov. 8, 2012

(54) SOLID CORE OPTIC FIBER

(75) Inventors: Manfred Kreuzer, Weiterstadt (DE); Karl-Heinz Haase, Pfungstadt (DE); Tobias Kipp, Rodermark (DE); Jochen Maul, Mainz (DE); Hagen Ruppin, Nauheim (DE); Rudolf Schulz, Weiterstadt (DE); Bernd Günther, Karlsruhe (DE)

(73) Assignee: HOTTINGER BALWIN MESSTECHNIK GMBH, Darmstadt (DE)

(21) Appl. No.: 13/263,644

(22) PCT Filed: Apr. 12, 2010
(86) PCT No.: PCT/DE2010/000411

§ 371 Date: May 17, 2012

(30) Foreign Application Priority Data
Apr. 10, 2009 (DE) 10 2009 016 834.6

(51) Int. Cl. G02B 6/44; B05D 5/00

(52) U.S. Cl. 385/102; 427/163.2

(57) ABSTRACT

The invention relates to a solid core optic fiber (1) as used in optical fiber technology to transfer optical signals, but also to transmit light for illuminating purposes. The solid core optic fiber (1) comprises a glass fiber (2) with a coating (3). The coating (3) comprises the following composition: a mixture of polyetheretherketone and an inorganic filler material in an admixture of at least 10 and a maximum of 40 wt. % having a particle size of 0.08 μm to 12 μm. The outer diameter of the coating (3) is 0.2 mm to 1.2 mm. The ratio D/d between the outer diameter D of the coating (3) and the diameter d of the glass fiber (2) is 2 to 6. A pressure of the coating (3) on the glass fiber (2) is such that essentially no relative motion can occur between the glass fiber (2) and the coating (3).

The invention relates to a solid core optic fiber as used in optical fiber technology to transfer optical signals, but also to transmit light for illuminating purposes or for treatment purposes in the field of medicine, such as the minimal-invasive surgery.

Optical wave-guides have a light transmitting medium made of glass or plastic material, hereinafter called fiber. The fiber is provided with a protective sheath, the material and structure of which meeting the protection requirements of the fiber. With a solid core optic fiber such as described in the European patent document EP 1 456 704 B1, for example, the sheath is directly applied onto a coating which the fiber is provided with. The coating is applied by using extrusion processes. The solid core optic fiber described in that document is structured so that the sheath is capable of sliding on the fiber. In order to obtain such antifriction properties, components such as talcum or Teflon in the form of intermediate layers are added to the sheath.

However, there are cases where sliding of the fiber in the sheath is not wanted. As described in the German patent specification DE 10 2004 045 775 B4, the sheath is displaced relatively to the fiber, that is, a relative movement between the fiber and the sheath takes place at temperature variations especially occurring in the engine room of a vehicle. Such a relative movement is caused by the different coefficients of expansion of the fiber material and the material of the sheath. This effect is called “pistoning” and affects the quality of signal transfer, because it is possible that the fiber ends move away from another at the points of connection, due to the displacement of the fiber in relation to the sheath. Therefore, numerous measures to prevent pistoning were suggested, such as described in the documents DE 19914743 A1, JP 04127107 A, DE 60104497 T2, WO 00/60382, KR 1020010113717 A, EP 1174746 A1 or DE 10044585 A1.

“Pistoning” also occurs when the solid core optic fiber is bent, because the material which the sheath is made of is tensioned at the outer bending radius and is compressed at the inner bending radius so that shear forces are generated between the fiber surface and the inside of sheath, which can cause a displacement of the fiber relative to the sheath. Due to stick-slip effects, mechanical stresses can be set up, which affect the optical properties of the fiber.

Therefore, one object of the invention is to provide a solid core optic fiber showing a low or, preferably, no pistoning effect so that it can be exposed to temperature variations and strong mechanical deformations without affecting the transfer quality of the optic fiber. Another object of the invention is to provide a method of making such a solid core optic fiber.

These objects are solved by a solid core optic fiber according to claim 1 and a method according to claim 10.

According to claim 1, the solid core optic fiber comprises a glass fiber with a sheath, with the sheath comprising the following composition: a mixture of poly-ether ether ketone and an inorganic filler in an admixture of at least 10 and maximum 40 percent by weight, with a particle size of 0.08 μm to 12 μm. The outside diameter of the sheath is 0.2 mm to 1.2 mm. The ratio Did between the outside diameter D of the sheath and diameter d of the glass fiber is 2 to 6. A Pressure of the sheath on the glass fiber is such that essentially no relative movement between the glass fiber and the sheath can occur.

The solid core optic fiber according to the invention comprises excellent mechanical properties, with the necessary optical properties maintained. The solid core fiber does not show any detectable pistoning effect even with temperature variations along the fiber. Also, a pistoning effect does not occur with bending of the solid core fiber in different directions repeatedly.

An additional positive effect is a high plasticity being reversible. The solid core fiber can permanently be bent by 90 degrees, for example. It is also possible to form a knot, provided that a minimum radius is kept. After that, the knot can be drawn open again and the solid core fiber can be re-straightened without affecting the optical parameters. Such a high plasticity, which solid core fibers according to prior art do not comprise, is especially important for running a solid core fiber along a wall having a complex shape, a wall in the engine room of a vehicle, for example, and also for concentrating numerous solid core fibers to form a cable harness. An inherent stability of the cable harness is gained by braiding or twisting the solid core fibers so that fixing tapes are not necessary. Solid core optic fibers can also be used in the field of medicine, in cases where very small areas have to be illuminated or treated, for example. Due to its plasticity, a solid core optic fiber can be bent at the final section thereof so that the region to be treated medically is accessible more easily.

According to claim 2, the pressure of the sheath on the glass fiber is at least 120 N/mm². With such a pressure, essentially no relative movement between the glass fiber and the sheath can occur. Thus, a pistoning effect does not occur even with temperature variations or mechanical deformations.

According to claim 3, the glass fiber comprises a glass core with a coating of ORMOCER^{□}. The ORMOCER^{□} coating has a chemical stability sufficient for extruding the sheath onto the glass fiber in the process of making a solid core optic fiber. This is not true of coatings made of acrylate or polyimide, which are usually used.

According to claim 4, the inorganic filler is a silicate; according to claim 5, the inorganic filler is a laminated silicate, and according to claim 6, the inorganic filler is talcum, chalk, calcium carbonate, barium sulfate, boron nitride, silicon dioxide or bentonite. These fillers are capable of giving the solid core optic fiber according to the invention the properties wanted, that is, no detectable pistoning effect and a high plasticity.

According to claim 7, the admixture of the inorganic filler is at least 25 percent by weight and maximum 40 percent by weight. Thus, the plastic properties can further be improved.

According to claim 8, the admixture of the inorganic filler is 27 percent by weight and maximum 33 percent by weight. Thus, the plastic properties can be improved still further.

According to claim 9, the particle size is at least 0.1 μm and maximum 10 μm. Such particle sizes enable a good connection between the sheath and the glass fiber to be gained.

According to claim 10, a method of making solid core optic fibers comprises the following steps: providing of a glass fiber and extruding of a sheath onto the glass fiber. The sheath comprises the following composition: a mixture of poly-ether ether ketone and an inorganic filler in an admixture of at least 10 and maximum 40 percent by weight, with a particle size of 0.08 μm to 12 μm. The outside diameter of the sheath is 0.2 mm to 1.2 mm. The ratio Did between the outside diameter D of the sheath and diameter d of the glass fiber is 2 to 6. After termination of the process, a pressure of the sheath on the glass fiber is such that essentially no relative movement between the glass fiber and the sheath can occur.

A solid core optic fiber made in accordance with the method as claimed has excellent mechanical properties with maintaining the required optical properties, does not show any traceable pistoning effect and has a high plasticity, as already explained in detail.

According to claim 11, parameters of extrusion are chosen so that, after termination of the process, the pressure of the sheath on the glass fiber is at least 120 N/mm². With such a pressure, essentially no relative movement between the glass fiber and the sheath can occur. Thus, a pistoning effect does not occur even with temperature variations or mechanical deformations.

According to claim 12, the step of providing a glass fiber comprises the step of providing a glass core and the step of coating the glass core with ORMOCER^{□}. The ORMOCER^{□} material has a chemical stability sufficient for extruding the sheath onto the glass fiber in the process of making the solid core optic fiber. This is not true of coatings made of acrylate or polyimide, which are usually used.

According to claim 13, the inorganic filler is a silicate; according to claim 14, the inorganic filler is a laminated silicate, and according to claim 15, the inorganic filler is talcum, chalk, calcium carbonate, barium sulfate, boron nitride, silicon dioxide or bentonite. These fillers are capable of giving the solid core optic fiber according to the invention the properties wanted, that is, no detectable pistoning effect and a high plasticity.

Below, the invention will be explained in detail by means of an exemplified embodiment in connection with schematic drawings.

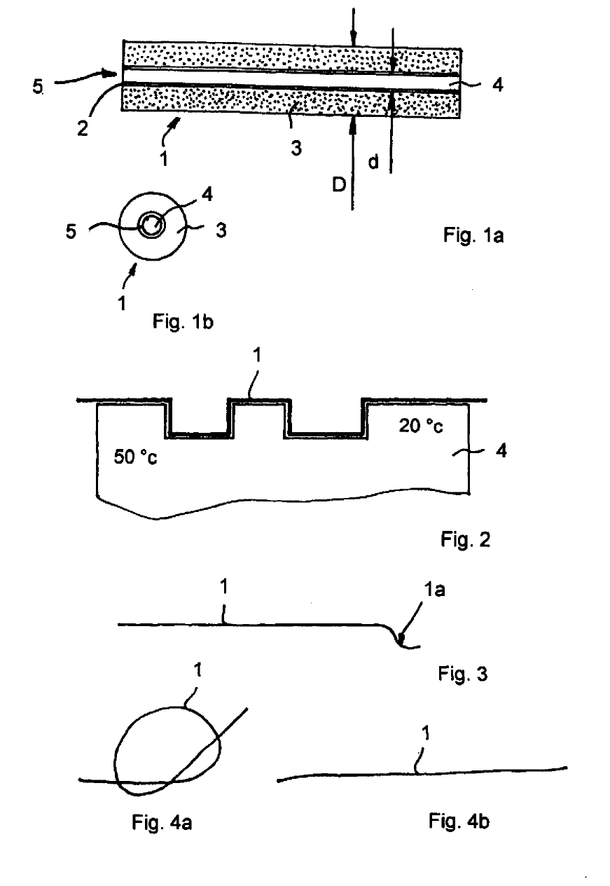

FIG. 1a is a longitudinal cross section of a solid core optic fiber according to the exemplified embodiment, in a magnified scale.

FIG. 1b is a cross-sectional view of the solid core optic fiber according to the exemplified embodiment, in a magnified scale.

FIG. 2 shows a first kind of application of the solid core optic fiber according to the exemplified embodiment.

FIG. 3 shows a second kind of application of the solid core optic fiber according to the exemplified embodiment.

FIG. 4a, b show examples of the plasticity of a solid core optic fiber according to the exemplified embodiment.

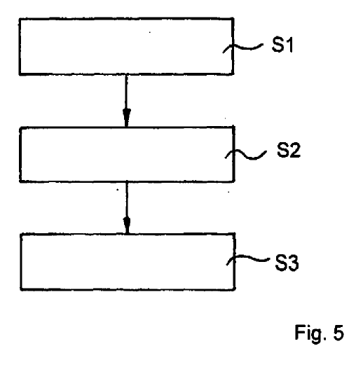

FIG. 5 is a flow chart illustrating fundamental steps of a method of making the solid core optic fiber according to the exemplified embodiment.

FIG. 1a is a longitudinal cross section of a solid core optic fiber 1 according to the exemplified embodiment, represented in a magnified scale. Reference mark 2 denotes a glass fiber and reference mark 3 denotes a sheath. FIG. 1b is a cross-sectional view thereof.

The sheath 3 can comprise the following composition: a mixture of poly-ether ether ketone and an inorganic filler in an admixture of at least 10 percent by weight and maximum 40 percent by weight, for example, with a particle size of 0.08 μm to 12 μm, for example. Hereinafter, poly-ether ether ketone is called PEEK, whilst the mixture of PEEK and the inorganic filler is called PEEKF.

The inorganic filler can be talcum (magnesium silicate, Mg3SO4O10(OH)2), chalk, calcium carbonate (CaCO3), barium sulfate (BaSO4), boron nitride (BN), silicon dioxide (SiO2), bentonite (main component (60-80%) is montmorillonite (laminated aluminum silicate, Al2{(OH)2/Si4O10}nH2O))), quartz, (SiO2), aluminum oxide (Al2O3), silicon carbide (SIC), hollow glass spherules, precipitated silicic acid, zinc sulfide (ZnS) or titanium oxide (TiO2), for example.

The glass fiber 2 can comprise a glass core 4 and a coating 5. The material of the coating 5 can be ORMOCER^{□}, for example, that is, an inorganic-organic hybrid polymer.

The outside diameter D of the sheath 3 can be 0.2 mm to 1.2 mm, for example. The ratio D/d between the outside diameter D of the sheath 3 and the diameter d of the glass fiber 2 can be 2 to 6, for example. As the exemplified embodiment is concerned, the diameter d of the glass fiber is 0.185 mm and the diameter D of the sheath is 0.6 mm.

A pressure of the sheath 3 on the glass fiber 2 can be such that essentially no relative movement between the glass fiber 2 and the sheath 3 and, thus, no pistoning effect occur. The pressure of the sheath 3 on the glass fiber 2 can be between 120 N/mm² and 216 N/mm², for example.

In the process of making the solid core optic fiber 1, the sheath 3, which the inorganic filler is distributed in, is applied to the glass fiber 2 by extrusion. Extrusion is performed at a high temperature, because the melting point of PEEKF is more than 370° C. During a slow cooling-down process and from a temperature limit on, at which the PEEKF begins to solidify, a certain pressure per degree of cooling is generated, due to different material expansions of the glass fiber 1 and the sheath 3. For example, the expansion coefficient of glass can be 0.5 ppm/K and that of PEEKF can be 25 ppm/K, from which a delta of 24.5 ppm/K results. The temperature limit, at which the PEEKF begins to solidify, can be about 170° C., for example. When the strain gauge is cooled from about 170° C. down to about 20° C., the calculation is 150 K×24.5 ppm/K, for example.

Thus, due to the different expansions of the materials which the glass fiber 1 and the sheath 3 are made of, shrinking occurs, with the result that a shrinkage join between the sheath 3 and the glass fiber 1 is formed. Thereby, the sheath 3 is tightly wedged to the glass fiber 1. This is effected by specific parameters of the extrusion process and by a specific composition of PEEFK which the sheath is made of.

FIG. 2 shows a first kind of application of a solid core optic fiber 1 according the exemplified embodiment. With this kind of application, the solid core optic fiber 1 is run on a substratum 6 having a complex surface shape. Due to its plasticity, the solid core optic fiber 1 can be pre-deformed so that it matches to this shape and can be run more easily. Even a temperature difference of 30° C., for example, as indicated in FIG. 2, does not affect the optical and plastic properties of the solid core optic fiber 1.

FIG. 3 shows a second kind of application of a solid core optic fiber 1 according to the exemplified embodiment. With this kind of application, a solid core optic fiber 1 is used for illumination with a medical treatment. A final section 1a of a solid core optic fiber 1 is bent so that it can be inserted into a narrow blood-vessel more easily, for example.

FIGS. 4a, b show examples of the plasticity of the solid core optic fiber 1 according to the exemplified embodiment. With these examples, the solid core optic fiber 1 has an outside diameter D of 0.7 mm and the glass fiber 2 has a diameter of 0.185 mm. With such dimensions, the solid core optic fiber 1 can be deformed permanently to a circle having a minimum diameter of 20 mm, as shown in FIG. 4a, and then, can be re-straightened, as shown in FIG. 4b. Furthermore, the solid core optic fiber 1 can be deformed permanently through 90 degrees with a radius of 2 mm as minimum and then, can be re-straightened.

An expert knows that these specific plastic properties enable numerous other cases of application to be realized.

FIG. 5 is a flow chart illustrating fundamental steps of a method of making solid core optic fibers 1 according to the exemplified embodiment. In step S1, a glass core 4 is provided. In step S2, a coating 5 is applied onto the glass core 4. Together, the steps S1 and S2 form a step of providing the glass fiber 2. In step S3, the sheath 3 is extruded onto the glass fiber 2.

With the method of making the solid core optic fiber 1 according to the exemplified embodiment, the parameters of extrusion can be chosen so that, after termination of the process, a pressure of the sheath 3 on the glass fiber 2 can be such that essentially no relative movement between the glass fiber 2 and the sheath 3 and thus, no pistoning effect occur. The pressure of the sheath 3 on the glass fiber 2 can be between 120 N/mm² and 216 N/mm², for example.

1. Solid core optic fiber comprising a glass fiber with a sheath, wherein
the sheath comprises the following composition: a mixture of poly-ether ether ketone and an inorganic filler in an admixture of at least 10 percent by weight and maximum 40 percent by weight, with a particle size of 0.08 μm to 12 μm,
the outside diameter of the sheath is 0.2 mm to 1.2 mm,
the ratio D/d between the outside diameter D of the sheath and the diameter d of the glass fiber is 2 to 6, and
a pressure of the sheath on the glass fiber is such that essentially no relative movement between the glass fiber and the sheath can occur.

2. Solid core optic fiber according to claim 1, wherein the pressure of the sheath on the glass fiber is at least 120 N/mm².

3. Solid core optic fiber according to claim 1, wherein the glass fiber comprises a glass core with a coating of ORMOCER^{□}.

4. Solid core optic fiber according to claim 1, wherein the inorganic filler is a silicate.

5. Solid core optic fiber according to claim 1, wherein the inorganic filler is laminated silicate.

6. Solid core optic fiber according to claim 1, wherein the inorganic filler is talcum, chalk, calcium carbonate, barium sulfate, boron nitride, silicon dioxide or bentonite.

7. Solid core optic fiber according to claim 1, wherein the admixture of the inorganic filler is at least 25 percent by weight and maximum 40 percent by weight.

8. Solid core optic fiber according to claim 1, wherein the admixture of the inorganic filler is at least 27 percent by weight and maximum 33 percent by weight.

9. Solid core optic fiber according to claim 1, wherein the particle size is at least 0.1 μm and maximum 10 μm.

10. Method of making a solid core optic fiber, which comprises the steps
providing (S1, S2) of a glass fiber and
extruding of a sheath onto the glass fiber, wherein
the sheath comprises the following composition:
a mixture of poly-ether ether ketone and an inorganic filler in an admixture of at least 10 percent by weight and maximum 40 percent by weight, with a particle size of 0.08 μm to 12 μm,
the outside diameter of the sheath is 0.2 mm to 1.2 mm,
the ratio D/d between the outside diameter of the sheath and the diameter d of the glass fiber is 2 to 6, and
after termination of the process, a pressure of the sheath on the glass fiber is such that essentially no relative movement between the glass fiber and the sheath can occur.

11. Method according to claim 10, wherein parameters of extrusion are chosen so that, after termination of the process, the pressure of the sheath on the glass fiber is at least 120 N/mm².

12. Method according to claim 10, wherein the step of providing a glass fiber comprises the steps (S1) of providing a glass core and the step (S2) of applying a coating of ORMOCER^{□} onto the glass core.

13. Method according to claim 10, wherein the inorganic filler is a silicate.

14. Method according to claim 10, wherein the inorganic filler is a laminated silicate.

15. Method according to claim 10, wherein the inorganic filler is talcum, chalk, calcium carbonate, barium sulfate, boron nitride, silicon dioxide or bentonite.
